(19) United States
(12) Patent Application Publication
(10) Pub. No.: US 2023/0070467 A1
(43) Pub. Date: Mar. 9, 2023

(54) SYSTEMS AND METHODS FOR RECOMMENDING INSURANCE

(71) Applicant: ROYAL BANK OF CANADA, Toronto (CA)

(72) Inventors: Isabel Jiyee LIM, Guelph (CA); Jordan William CURNEW, Lynden (CA); Maria SOHAIL, Mississauga (CA); Jaspreet Singh SANDHU, Thornhill (CA); Chai LAM, Toronto (CA); Samuel PASSAFIUME, Toronto (CA)

(21) Appl. No.: 17/895,235

(22) Filed: Aug. 25, 2022

Related U.S. Application Data
(60) Provisional application No. 63/237,739, filed on Aug. 27, 2021.

(51) Int. Cl. G06Q 40/08; G06Q 30/02

(52) U.S. Cl. CPC G06Q 40/08; G06Q 30/0203

(57) ABSTRACT

An insurance recommendation engine receives customer data and using trained models recommends one or more insurance products that are suitable for the customer. The recommendation engine also provides an explanation as to why the particular products have been recommended. The recommendation models are incorporated into a system that can improves the customer's experience.

### RELATED APPLICATION

The current application claims priority to U.S. Provisional application 63/327,739 filed Aug. 27, 2021 and titled “SYSTEMS AND METHODS FOR RECOMMENDING INSURANCE,” the entire contents of which are incorporated herein by reference in their entirety.

### TECHNICAL FILED

The current disclosure relates to insurance products and in particular to computer implemented systems and methods for providing insurance recommendations.

### BACKGROUND

Understanding the value of different life insurance products and selecting one that best meets one's needs is complex. Hence, most insurance products are sold, not bought, and leverage the skills of advisors and brokers to engage clients and identify available insurance products that best match their needs.

Insurance is an industry historically recognized for its poor public perception. Much of this negativity stems from the stigmatic nature of the quotation process, where clients are asked to candidly share sensitive information by completing a Personal Needs Assessment (PNA) form. The PNA form is an industry-standard form having questions with the intent of determining a client's insurance coverage requirements, given both their personal and financial information.

The PNA Form is generally first completed during an initial meeting between a client and an advisor. It prompts the collection of a copious amount of financial data, including net-value assets, outstanding liabilities, and employment details, to generate an insurance recommendation based on a formulaic procedure. As a client's needs change, the PNA form may again be completed or updated in successive meetings with the agent; however, many clients may not update the PNA forms and as such the client's insurance coverage may not be appropriate or ideal as the client's insurance needs change.

Additional, alternative and/or improved systems and methods capable of providing insurance recommendations for clients are desirable.

### SUMMARY

In accordance with the present disclosure, there is provided a computer implemented method of recommending insurance policies comprising: applying one or more trained policy recommendation models to personal needs assessment (PNA) data collected from an insurance customer to generate a recommendation of one or more insurance policies each of the insurance policies including a policy type and policy amount, each of the trained policy recommendation models generating a policy recommendation based on a plurality of respective features; applying the generated recommendation of the one or more insurance policies to a policy explainability model to identify one or more of the plurality of features of the respective models that led to the generated recommendation; mapping the one or more features identified by the policy explainability model to a human-understandable explanation of the policy recommendation; and outputting the generated policy recommendation and the human-understandable explanation of the policy recommendation for presentation to the insurance customer.

In a further embodiment of the method, each of the trained policy recommendation models receive as input: life stage milestone data; profile demographic data; historical purchase data; and the PNA data.

In a further embodiment of the method, each of the trained policy recommendation models are trained on one or more of: historical customer dataset; and 3rd party dataset.

In a further embodiment of the method, the method further comprises: collecting the PNA data from the insurance customer; and fusing the PNA data with data from the 3rd party dataset prior to applying the PNA data to the one or more trained policy recommendation models.

In a further embodiment of the method, one or more of the policy recommendation models comprises: a policy model for recommending a policy type based on the PNA data; and a policy amount model for recommending a policy amount based on the PNA data and recommended policy type.

In a further embodiment of the method, the policy model is a classifier model and the policy amount model is a regression model.

In a further embodiment of the method, one or more of the policy recommendation models further comprise: a policy sub-type model for recommending a sub-type of the policy type; a first policy model for recommending a first policy sub-type based on the PNA data when the policy sub-type model recommends a first sub-type of the policy type; a first policy amount model for recommending a policy amount based on the PNA data and recommended first policy sub-type when the policy sub-type model recommends a first sub-type of the policy type; a second policy model for recommending a second policy sub-type based on the PNA data when the policy sub-type model recommends a second sub-type of the policy type; and a second policy amount model for recommending a policy amount based on the PNA data and recommended second policy sub-type when the policy sub-type model recommends a second sub-type of the policy type.

In a further embodiment of the method, the method further comprising collecting the PNA data by: presenting the insurance customer with a first set of questions to collect a first subset of the PNA data; and determining a second set of questions to collect a second subset of the PNA data based on the first subset of PNA data.

In a further embodiment of the method, the first set of questions and the second set of questions are determined based on the one or more policy recommendation models applied t the first subset of the PNA data.

In a further embodiment of the method, the first set of questions and the second set of questions are determined based on determined feature importance of the one or more policy recommendation models.

In a further embodiment of the method, the collected PNA data includes collecting data on one or more of: life stage milestones of the insurance customer that have occurred; and anticipated life stage milestones that are expected to occur.

In a further embodiment of the method, the one or more trained policy recommendation models generate the policy recommendation by: predicting a persona type of the insurance customer using the collected PNA data; mapping the persona to corresponding life stage milestones; and determining the policy recommendation based on the corresponding life stage milestones of the predicted persona.

In a further embodiment of the method, the method further comprising: generating and storing a future contact plan based on the predicted life stage milestone timeline, wherein the future contact plan comprises dates for performing a contact action comprising one or more of: contacting the insurance customer to update collected PNA data of the insurance customer; and contacting the insurance customer to recommend an insurance product or change to an existing insurance product.

In a further embodiment of the method, the method further comprising: receiving an indication of the insurance customer accepting or rejecting the recommended insurance product; and re-training one or more of the policy recommendation models using the received indication.

In a further embodiment of the method, the recommended insurance product or change to the existing insurance product is determined using the one or more trained policy recommendation models and predicted PNA data for each life stage milestone of the predicted life stage milestone timeline.

In a further embodiment of the method, the method further comprising: periodically processing the stored future contact plan to determine if a date of the dates for contacting the insurance customer has occurred; and when one of the dates of the dates for contacting the insurance customer has occurred, performing the contact action.

In a further embodiment of the method, the second set of questions is determined based on one or more characterizing models that characterize one or more characteristics of the customer.

In a further embodiment of the method, one of the one or more characterizing models comprises a smoker propensity model that characterizes the customer as a smoker or not.

In a further embodiment of the method, at least a portion of the PNA data is processed using natural language processing (NLP).

In a further embodiment of the method, the method further comprising collecting the PNA data by: collecting a first portion of the PNA data through a first user interface channel; storing the first portion of the PNA data; subsequently retrieving the first portion of the PNA data and identifying a subsequent question for collecting a second portion of PNA data; and collecting the second portion of PNA data through a second user interface channel.

In a further embodiment of the method, the method further comprising: predicting a probability that a plurality of lifestage milestones will occur within a given set of time; predicting a persona type of the insurance customer; predicting future insurance needs of the insurance customer based on the predicted probability that the plurality of lifestage milestones will occur and the predicted persona type; determining a difference between current insurance of the insurance customer and future insurance needs; and based on the determined difference, generating a contact action associated with the insurance customer.

In accordance with the present disclosure, there is further provided a non-transitory computer readable medium storing instructions which when executed by a processor of a computing device configure the computing device to perform a method comprising: applying one or more trained policy recommendation models to the personal needs assessment (PNA) data collected from an insurance customer to generate a recommendation of one or more insurance policies each of the insurance policies including a policy type and policy amount, each of the trained policy recommendation models generating a policy recommendation based on a plurality of respective features; applying the generated recommendation of the one or more insurance policies to a policy explainability model to identify one or more of the plurality of features of the respective models that led to the generated recommendation; mapping the one or more features identified by the policy explainability model to a human-understandable explanation of the policy recommendation; and outputting the generated policy recommendation and the human-understandable explanation of the policy recommendation for presentation to the insurance customer.

In accordance with the present disclosure, there is further provided a computing device comprising: a processor for executing instructions; and a memory storing instructions which when executed by the processor configure the computing device to perform a method according to: applying one or more trained policy recommendation models to the personal needs assessment (PNA) data collected from an insurance customer to generate a recommendation of one or more insurance policies each of the insurance policies including a policy type and policy amount, each of the trained policy recommendation models generating a policy recommendation based on a plurality of respective features; applying the generated recommendation of the one or more insurance policies to a policy explainability model to identify one or more of the plurality of features of the respective models that led to the generated recommendation; mapping the one or more features identified by the policy explainability model to a human-understandable explanation of the policy recommendation; and outputting the generated policy recommendation and the human-understandable explanation of the policy recommendation for presentation to the insurance customer.

### BRIEF DESCRIPTION OF THE DRAWINGS

In the accompanying drawings, which illustrate one or more example embodiments:

FIG. 1 depicts a system providing an insurance recommendation engine;

FIG. 2 depicts components of a life insurance recommendation model;

FIG. 3 depicts components of a critical illness insurance recommendation model;

FIG. 4 depicts a method of recommending insurance policies;

FIG. 5 depicts components of an insurance sales system incorporating an insurance recommendation;

FIG. 6 depicts components of a life-stage contact planner;

FIG. 7 depicts predicting personas and their mapping to life-stage milestones;

FIG. 8 depicts predicting personas and their mapping to life-stage milestones; and

FIG. 9 depicts components of a PNA data collection component.

### DETAILED DESCRIPTION

Insurance recommendations may be provided to a client leveraging machine learning to make a more informed, personalized recommendation based on historic purchasing data and client information. In addition to using machine learning to provide improved insurance recommendations, the system described further below can provide an explanation of the basis for the recommendations. Further, the system can provide a tailored PNA data collection experience for advisors and customers, making the collection of personal information a less difficult process. In addition to providing an insurance recommendation based on the collected PNA data, the system may also generate a contact plan for the advisor, or an automated system, to contact the client as life milestones may occur and so change the insurance needs.

As different life events occur in the client's life, such as purchasing a new house, the birth of their first child, etc. their insurance needs may change. There is currently no systematic way of collecting such information, meaning that insurance provides typically rely on the advisors to keep track of, and reach out to clients on their own. This issue can be further perpetuated by the fact that clients may be moved to other Advisors with no knowledge of such life events. No two Clients who partake in the insurance purchasing process have the same life journey, nor do they have identical knowledge with regards to the industry space. For example, some clients may be highly prepared for the initial advisor meeting, while others may have no idea of their needs or insurance options. The current system can provide an improved process for PNA data collection that can collect details about the client's life milestones or other significant events. Using the collected PNA data, the systems can assist advisors in reaching out to clients down the line so that they can connect with clients as their insurance needs change.

With the collected PNA data, a recommendation engine with machine learning models trained on historical data can provide a recommendation that accurately reflects the specific needs and requirements of the client with an unparalleled level of personalization. Furthermore, the recommendation engine can be offered as a service through third party brokers, financial partners, and self-service allowing clients to receive insurance recommendations through their preferred channel. That is, the recommendation engine can be utilized through multiple sales channels to ensure that clients can purchase insurance in a way that best suits their individual needs. For example, the recommendation engine can be utilized in a self-service webpage on the insurance provider's website, and offered to third parties such as Brokers. In addition to the insurance recommendations, the recommendation engine may also provide an explanation as to why the particular insurance product(s) and amounts were provided. That is the recommendation engine can provide the client with a personalized justification as to what their product recommendation is, and why it's the right fit for them. Explainability is powered by the recommendation engine through machine learning feature importance, and can be accompanied by easy to understand descriptions and/or graphics and explanations to help clients navigate the complexities of purchasing insurance. The explainability can provide traceability to enable the advisor to clearly explain the reasons for why a particular product and coverage amount was recommended. The recommendation engine may include key performance indicators (KPIs) for model accuracy and transparency to promote trust in the recommendations.

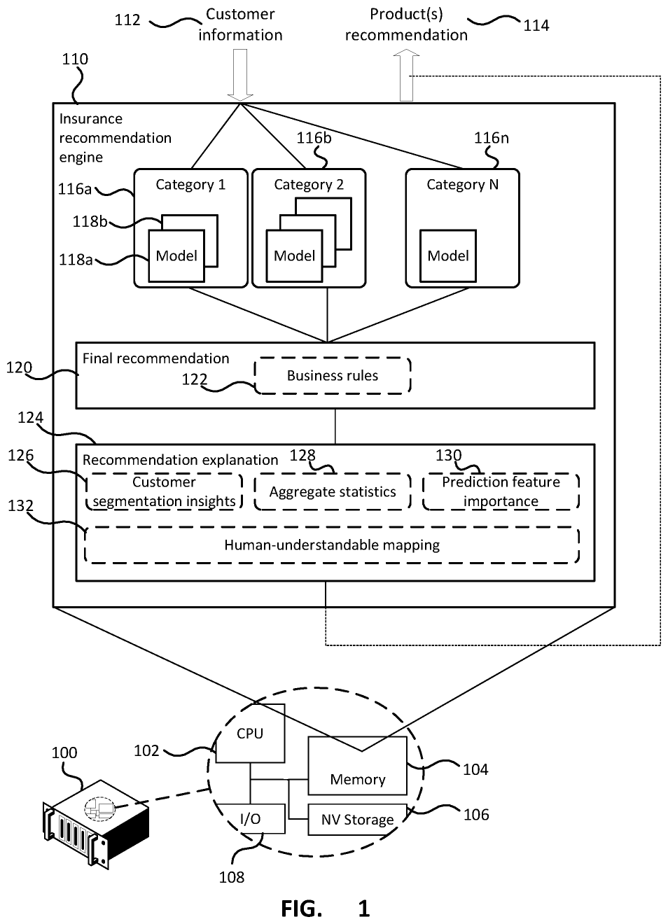

FIG. 1 depicts a system providing an insurance recommendation engine. The system for providing an insurance recommendation engine is depicted as a server 100, however it will be appreciated that similar functionality may be provided by one or more interacting servers, which may be communicatively coupled together by one or more communication networks such as the Internet, or other networks. The server 100 comprises a processor 102 that controls the server's 100 overall operation by executing instructions. The processor 102 is communicatively coupled to and controls several subsystems. These subsystems include one or more memory units 104, such as random access memory (“RAM”) 104, which store computer program code for execution at runtime by the processor 102; non-volatile storage 106, which stores the computer program code executed by the RAM 104 at runtime; comprise input/output (I/O) interfaces 108 that allow additional components to be coupled to the system, either internally or externally. For example, the additional components may comprise, for example, any one or more of a keyboard, mouse, touch screen, voice control; a display controller, which is communicatively coupled to and controls a display; and a network interface, which facilitates network communications with a wide area network and other computing devices. The non-volatile storage 106 has stored on it computer program code that is loaded into the RAM 104 at runtime and that is executable by the processor 102. When the computer program code is executed by the processor 102, the processor 102 causes the server 100 to implement various functionality, including for example, the insurance recommendation engine functionality 110.

The insurance recommendation engine functionality 110 receives customer information 112 and provides insurance product recommendations 114, which may provide one or more insurance products and associated face amounts for the products. The received customer information 112 may include PNA data collected from the customer, possibly combined with other information from additional data sources. The customer information 112 can be provided to one or more recommendation models 116a, 116b, 116n (referred to collectively as recommendation models 116). Each of the recommendation models 116 may provide a recommended insurance product for a particular category of insurance products, such as life insurance, critical illness insurance, disability insurance, etc., based on the customer information 112, or a portion of the customer information. Each of the recommendation models 116 may have one or more models 118a, 118b that are trained on the on historical customer data. Each of the recommendation models 116 provides a recommended insurance product along with a face value amount for the recommended insurance product.

The insurance recommendations from the recommendation models116, may be provided to final recommendation functionality 120 that combines the recommendations together to provide a final recommendation for the customer. The final recommendation may be a simple combination of the individual recommendations or may use additional business rules 122 for providing the final recommendation. Additionally or alternatively, the business rules may be used to provide additional or alternative recommendations. For example, if new insurance products are added, they may be difficult to recommend as the recommendation models 116 are trained on historical data and as such, the business rules can be used to recommend new products to appropriate customers until sufficient historical data is available to retrain an existing recommendation model or train a new recommendation model to incorporate the new insurance product in the final product recommendation.

The final recommendation is provided to recommendation explanation functionality 124. The explanation functionality 124 attempts to provide an easily understandable explanation as to why the recommendation engine provided the particular recommendation. The explanation functionality 124 may use customer segmentation insights 126 for providing insights into the groups or segments of users. Aggregate statistics 128 may also be used to provide information about customers such as those who have purchased similar product. Further prediction feature importance functionality 130 may be used to provide an indication of which features, and possibly the values or ranges of values, were important in reaching the recommendation. The feature importance functionality may use local and global feature importance for the recommendation models. The feature importance functionality may be performed using various techniques to provide insight into the most salient factors, along with positive and negative impacts, a particular variable has on the predictions. The explanations provided by the feature importance functionality may provide an indication of how the recommendation was reached, however they may not be particularly insightful or easy to understand for humans. For example, an indication that the particular value of an average income feature pushed a certain prediction higher from a base value, may be difficult for people to understand. Human-understandable mapping functionality 132 may take the explanations from the prediction feature importance functionality 132 and map them to a human-understandable explanation. The human-understandable explanation may include information from the customer segmentation insights and aggregate statistics. The human-understandable explanation may include text descriptions, graphs and/or other graphics for providing an easily understood explanation of why the recommendations were made. The recommended insurance type(s)/face amount(s) and the explanations of the recommendations may be output separate from each other or together.

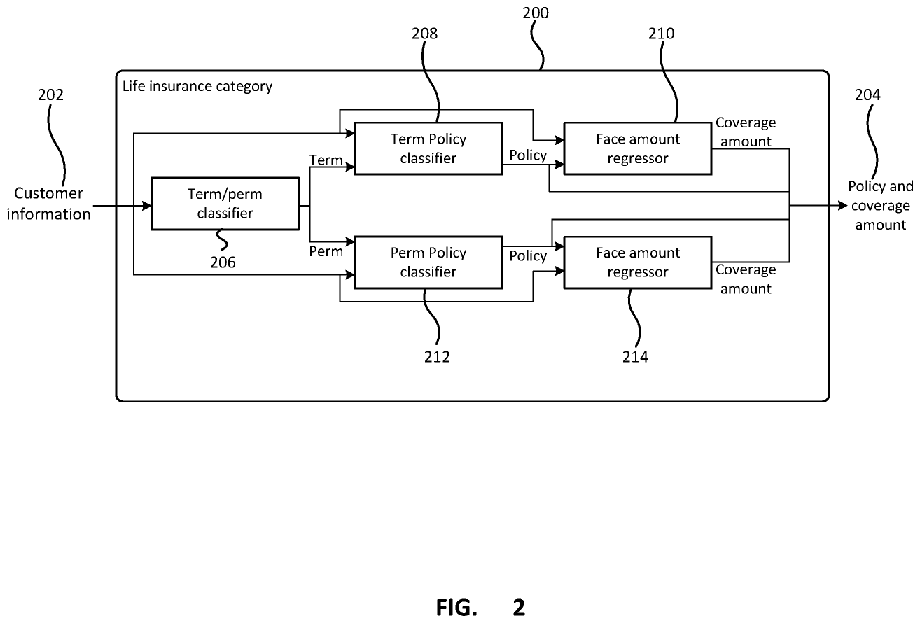

FIG. 2 depicts components of a life insurance recommendation model. While a specific example architecture of the model is depicted in FIG. 2 it will be appreciated that the life insurance recommendation model may use other architectures for providing the recommendation. The life insurance recommendation model 200 receives customer information 202 and provides a recommended life insurance policy and coverage amount 204. The insurance recommendation model 200 may be trained using life insurance customers datasets. As depicted the customer information is first provider to a term/perm classifier 206 that provides a classification for the customer information for the type of life insurance that is recommended for the customer, which may be term life insurance or perm life insurance. The term/perm classifier may be based on different classifiers, such as an XGBoost classifier, random forest classifier, or an LGBM classifier. For each classification option, i.e. term or perm, there may be a respective processing branch that provides the recommended insurance policy. For example, for term classifications the processing may comprise a term policy classifier 208 that receives the customer information and outputs one or more term policies which may be passed to a face amount regressor 210 that determines a coverage face amount for the term policy and outputs the policy and coverage amount 204. The term policy classifier may be based on different classifiers, such as a random forest classifier, an LGBM classifier, or an XGBoost classifier and the coverage face amount regressor may be a random forest regressor or other type of regressor.

For perm classifications the processing may comprise a perm policy classifier 212 that receives the customer information and outputs one or more perm policies which may be passed to a face amount regressor 214 that determines a coverage face amount for the perm policy and outputs the policy and coverage amount 204. The perm policy classifier may be based on different classifiers, such as an LGBM classifier, a random forest classifier, or an XGBoost classifier and the coverage face amount regressor may be a random forest regressor or other type of regressor.

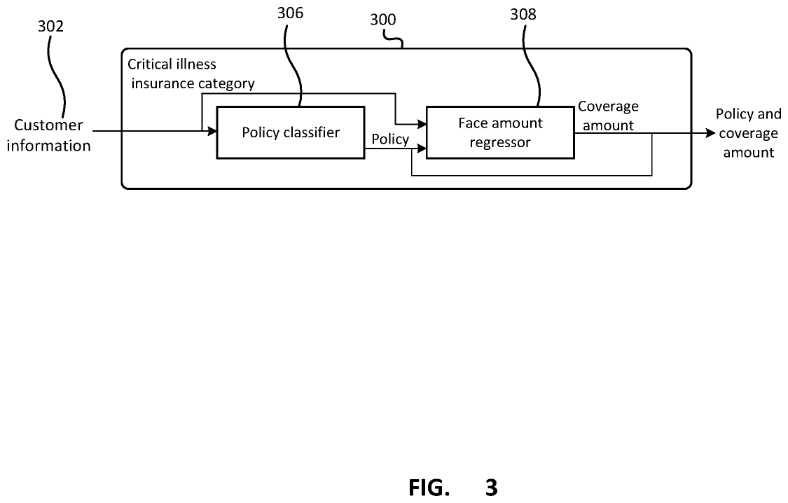

FIG. 3 depicts components of a critical illness insurance recommendation model.

While a specific example architecture of the model is depicted in FIG. 3 it will be appreciated that the life insurance recommendation model may use other architectures for providing the recommendation. The critical illness insurance recommendation model 300 receives customer information 302 and provides a recommended critical illness insurance policy and coverage amount 304. The insurance recommendation model 300 may be trained using critical illness insurance customers datasets. As depicted the customer information is provided to a critical illness policy classifier 306 that receives the customer information and outputs one or more critical illness policies which may be passed to a face amount regressor 308 that determines a coverage face amount for the critical illness policy and outputs the policy and coverage amount 304. The critical illness policy classifier may be based on different classifiers, such as an XGBoost classifier, a random forest classifier, or an LGBM classifier and the coverage face amount regressor may be a random forest regressor or other type of regressor.

A similar model architecture as described above with regard to FIG. 3, may be used for recommending other types of insurance such as disability insurance. While different models for different categories of insurance may use a similar structure, the types of the classifiers and regressors of the different models may be varied.

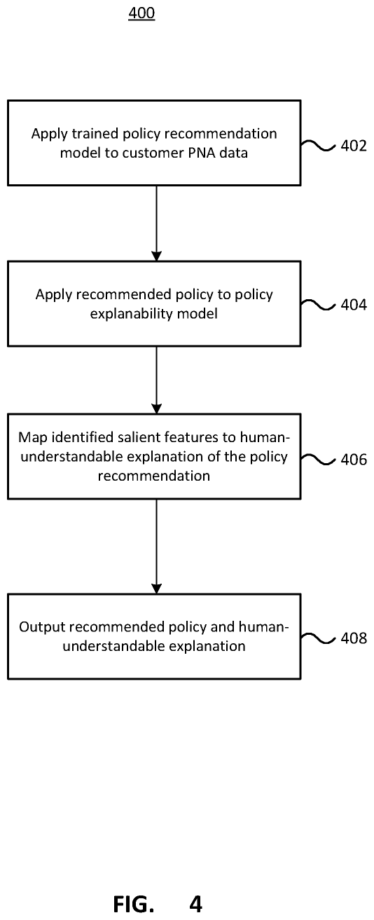

FIG. 4 depicts a method of recommending insurance policies. The method 400 receives customer data that may include PNA data collected from the customer including the customer's personal information, financial information as well life-stage milestones. The customer data may also include data from one or more other datasets including for example demographic data by postal code or ZIP code, insurance purchasing behaviors by postal code or ZIP code. One or more trained policy recommendation models are applied to the customer data (402) collected from an insurance customer to generate a recommendation of one or more insurance policies each of the insurance policies including a policy type and policy amount. Each of the trained policy recommendation models generates a policy recommendation based on a plurality of respective features from the customer data. The policy recommendation models are trained based on historical customer data, which may include customer data collected from PNA forms, customer's life-stage milestones, as well as data from other datasets such as the demographic data and/or the insurance purchasing data. The recommended insurance policies are applied to a policy explainability model (404) that identifies one or more of the plurality of features of the respective recommendation models that led to the generated policy recommendation. The salient features identified by the policy explainability model are mapped to human-understandable explanation of the policy recommendation (406) and the human-understandable explanation and recommended policy may then be output (408) for the customer.

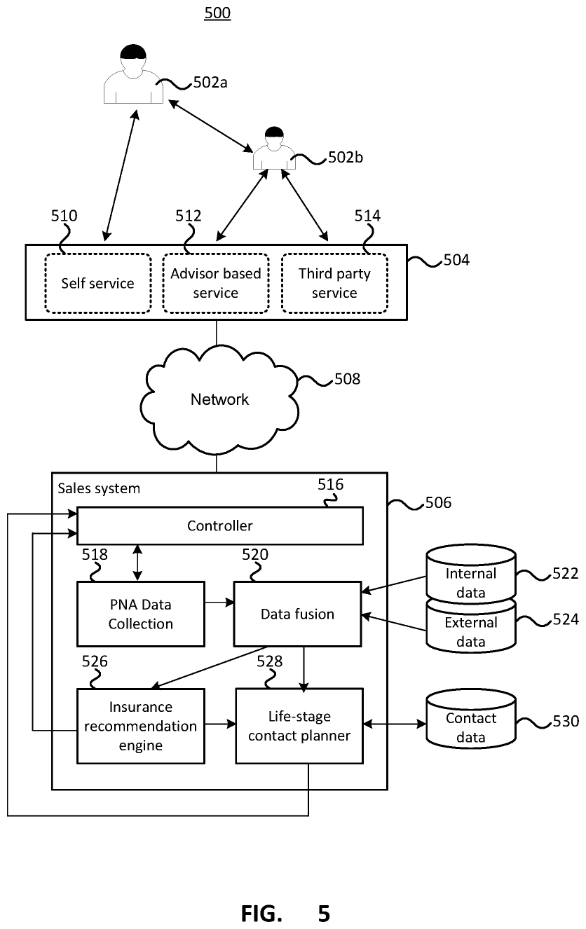

FIG. 5 depicts components of an insurance sales system incorporating an insurance recommendation. The system 500 may be used by an insurance customer 502a either directly or through an advisor or broker 502b. The customer 502a and/or advisor/broke 502b may interact with user interface components 504 that communicate with a sales system 506. The user interface components 504 and the sales system 506 may communicate with each other via one or more communication networks 508. The user interface components 504 may include a self-serve component 510 that provides a user interface, such as a website or web app that can be used directly by the customer 502a. The user interface components 504 may include additional or alternative interface components such as an advisor based service interface 512 that provides an interface for advisors to the sales system, or a third party service interface 514 that provides an interface to third party advisors or brokers.

The functionality of the sales system 506 may be implemented on one or more servers (not shown) similar to the server 100 described above. The sales system may include controller functionality 516 that controls the operation and interaction of the components of the sales system. The controller functionality 516 may provide an interface between the user interface components 504 and the sales system 506. The sales system 506 may include PNA data collection functionality 518 that collects PNA data from the customer. The PNA data collection functionality 518 can provide questions for the collection of the PNA data. The questions may be based on the previously provided response to the other questions so that the PNA data collection functionality provides the next best question for the data collection. The PNA data collection functionality 518 may collect the personal and financial data from customers as well as life-stage milestones that have occurred and/or are expected to occur or possibly not occur. The PNA data collection functionality 518 may include natural language processing (NLP) for processing text provided. For example, while information on the type of job or employment may be useful for predictions of insurance needs, it can be described in a wide range of ways that reduces its usefulness. NLP process can help characterize such free form text into a set of possible values making it more useful for predictions.

The PNA data collected by the PNA data collection functionality 518 may be passed to data fusion functionality that fuses the collected personal data with other data sources, which may include both internal data sources 522 and external data sources 524. The internal dataset may include customer data including the results of the insurance recommendation engine. The external data sets may include demographic data in Canada by postal codes, and/or in the US by ZIP codes as well as insurance purchasing behaviors in Canada by postal codes, and/or in the US by ZIP codes.

The fused customer data may be passed to insurance recommendation engine functionality 526, which may be similar to the recommendation engine described above. The recommendation engine 526 receives the fused customer data and uses trained models to recommend one or more insurance products to the customer as well as provide an explanation of why the recommendation was made. The models of the insurance recommendation engine may be trained and retrained using the fused data. The recommended insurance policies and explanation may be provided back to the controller 516, or possibly directly to the user interface components 504. The recommended insurance policies and explanation may be stored in the internal data source 522.

The recommended insurance policies and explanation may be provided to life-stage contact planner functionality 528. The contact planner functionality attempts to estimate times to contact the customer to update their customer information and possibly offer new insurance products. The contact planner functionality 528 may create a contact schedule that can be stored in a contact database 530 and acted upon at the appropriate time. For example, the contact planner functionality may determine that the customer should be contacted in 1 year to discuss additional life insurance. The scheduled contact may be acted upon, either using an automated system to communicate with the customer such as by email, or by providing the contact plan to the customer through an advisor or broker.

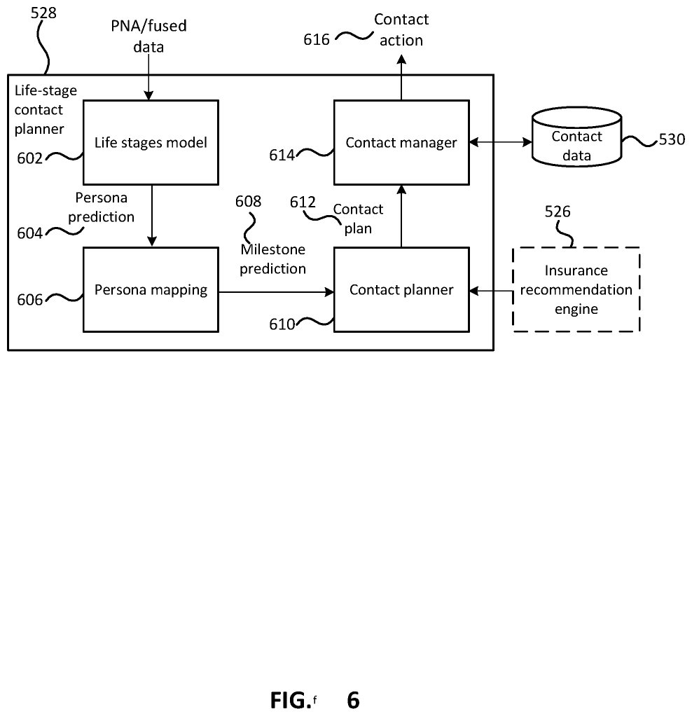

FIG. 6 depicts components of a life-stage contact planner. The life-stage contact lanner may include a life stages model functionality 502 that provides a trained model for receiving PNA fused data and attempts to predict a persona 604 that matches the customer. The persona may provide a broad classification of the customer that can provide useful information for predicting the future needs of the customer. The life stage model functionality may provide a current predicted persona as well as estimate future personas.

The predicted persona may be passed to a persona mapping functionality 606 that maps the predicted personas to life-stage milestones 608. The life stage milestones may provide estimated events and associated risk based on an estimated probability of the event occurring. The milestones predictions may be passed to a contact planner functionality 610 that uses the predicted milestone events, and associated risk levels, to generate a contact plan 612. The contact planner may use the insurance recommendation engine 526 for estimating an insurance product for the customer based on predicted milestones that may occur in the customer's life journey. The contact plan functionality 612 may generate a contact plan for contacting the customer at different times to possibly discuss recommended insurance products or discuss the customer's life stage milestones that may have occurred.

The contact plan 612 may be provided to contact manager functionality 614 that manages contacting the customer based on the contact plan. The contact manager functionality 614 may store the contact plan in the contact database 530. The contact manager may contact the customers, either directly through one or more communication channels such as email, text messages, or indirectly through an advisor or broker. For example, the contact manager may schedule emails to be sent to the customer, or possibly may generate calendar reminders for the advisors or brokers to act on.

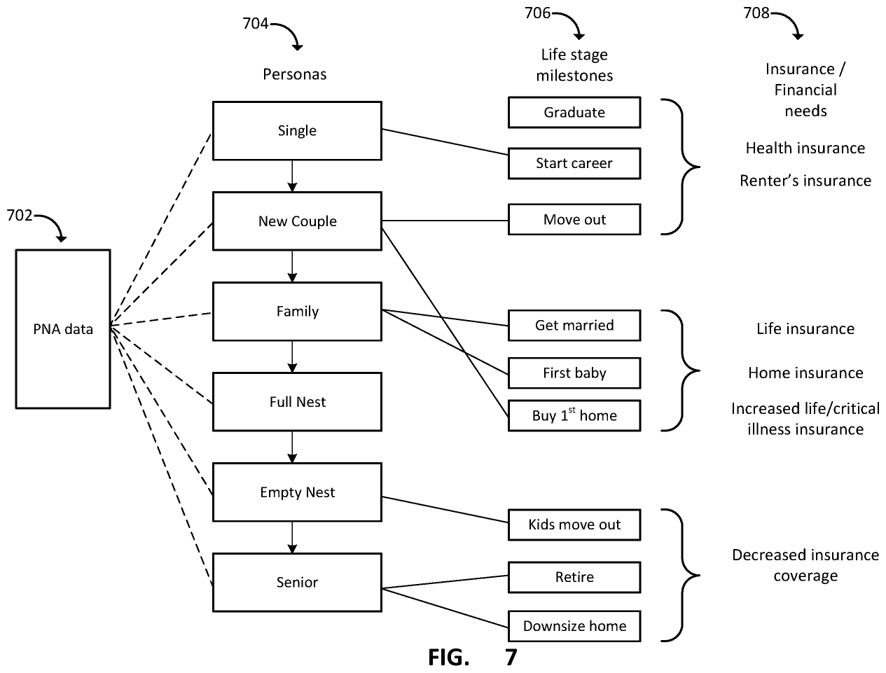

FIG. 7 depicts predicting personas and their mapping to life-stage milestones. As depicted, collected PNA data 702, which may be fused with additional data may be used to predict one or more personas 702 associated with the customer. The personas 704 may describe different stages of the customer. The customer may proceed from one persona to another as they progress through their life journey. The personas 704 depicted in FIG. 7 are associated with an individual that is a young single person starting a new career and meets a partner and buys a house and starts a family. The kids eventually move out and the customer retires. Each of the personas may be associated with one or more life stage milestones 706 or events along with risks of the events. The milestones 706 may be associated with respective insurance needs. The PNA data may be used to predict a current persona as well as future personas and then mapped to current and future life stage milestones that may occur. The predicted life-stage milestones may then be used in generating the contact plan.

The life stage contact planner functionality can provide a progressive recommendation service driven by personas and life stages. Predicted personas may be mapped to corresponding common life stage milestones with risk scores at each milestone to determine the most cost effective product to cover needs at each life stage and generate recommendations that meet coverage needs at the right time. For example, a millennial with no or few dependents may be better off with a term product vs a whole life product.

Life events information captured either during the needs analysis with the advisor or via the self-serve channel can be used to predict the next best time to contact the client and also the next best product to discuss with the client. Using prediction models, life event predictions can also identify potential risks and the probability of the event occurring based on where a person is in the life journey. This may allow an advisor to help the client plan for the risk e.g. mitigate the impact of financial loss in case of disability.

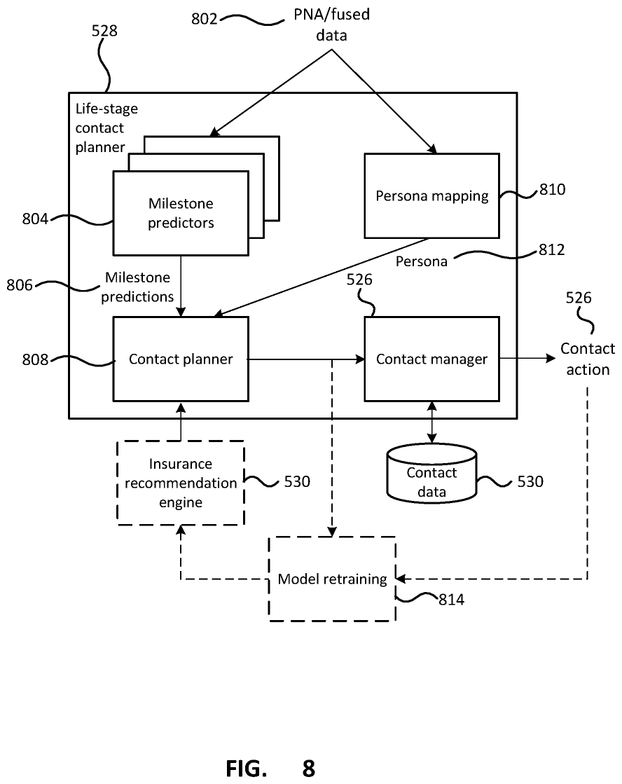

FIG. 8 depicts an alternative arrangement for predicting personas and their mapping to life-stage milestones. The life-stage contact planner 528 is similar to those described above and uses PNA/fused data 802 to generate a contact action 526, which may be for example setting a meeting or discussion with a client to discuss possible changing insurance needs. As depicted, the PNA/fused data 802, which may include the data received from the personal needs assessment as well as other available data including historical records such as previous PNA data, purchasing/banking details if authorized by the user, and other possible data sources that may be provided by 3rd parties. This 3rd party data may include data such as population and demographic statists, which may be aggregated at different levels.

The life-stage contact planner 528 may include a plurality of life milestone predictors 804 that provide a prediction, given the PNA/fused data, that a particular life milestone will occur within a particular range of time such as 6 or 12 months. For example, one model may predict if the user will have a baby in the next 12 months, a different model may predict if the user will get married in the next year, a different model may predict if the user will begin caring for an elder in the next 12 months, a different model may predict if the user has a first job, a different model may predict a future promotion, a different model may predict possible job loss, and a different model may predict upcoming retirement.

The models may be trained on historical data and may be based on various different information. For example, the baby model may consider increases in RESP deposits, and savings and investment accounts such as mutual funds and GICs show increases over a shorter time horizon, perhaps as a result of a family unit being formed and assets being combined. Other transactions indicate purchase of childcare products, age range of the individual, recent marriage date, increase in saving account balance. The marriage model may consider assets are being combined, with investments such as RRSP and mutual funds increasing sharply over several months (Consolidation), transactions indicate marriage expenses. The caregiver model may consider both mutual funds and GIC balances are increasing, potentially an indication of wealth transfer and provision of stable income to provide care (Transfer). Transactions indicate care giving expenses. The first job model may consider savings being top of mind for the client, with majority of the increase in HISA and Registered Savings as well as TFSA increase and increase in clothing and transportation expenses. The promotion model may consider increase in savings and investments deposits and large increases to investment accounts e.g. Mutual Funds. The job loss model may consider a decline in primarily savings accounts balance and to a lesser degree investments and a decrease in transportation expenses. The retirement model may consider age range, deposits from CPP, increase in travel expenses, professional, reduction in RSP contributions

The life stage contact planner may apply each of the milestone predictors to the PNA/fused data 802 and the most likely predictors 806 may be provided to a contact planner functionality 808. The milestones may be selected in various ways such as providing the milestone with the highest probability of occurring, or providing the milestones that have a probability of occurring above a threshold.

The PNA/fused data 802 may also be provided to a persona mapping functionality 810. The persona mapping may output a probability, or probabilities, that the client with the PNA/fused data is a particular persona. The most likely persona, or possibly personas, are also provided to the contact planner 808. The contact planner may use both the determined persona and the predicted next life stage milestone to determine possible changes in the client's insurance needs. Additionally or alternatively, the contact planner may use only one of the determined persona or the predicted next life stage milestones to determine possible changes in the client's insurance needs. The contact planner 808 may provide the milestones and personas to the insurance recommendation engine 530. The insurance recommendation engine 530 may provide insurance recommendations that meet the future needs of the client which may be compared to the client's current insurance to determine possible changes. Depending upon the determined changes the contact manager 526 may determine the next contact action 526. The contact manager may use contact data 530 to generate the next contact action. For example, if the change is not a significant difference in insurance, the contact manager may simply send an email to the client to advise them of the possible change. If there is a significant change in possible insurance needs, the contact manager may arrange a call for an insurance agent to contact the client to discuss the insurance needs. The contact manager may also generate a script or notes for the insurance agent to use during the call.

In addition to determining recommended insurance options, the system may include a model retraining functionality 814 that can receive the recommended insurance option determined by the contact planner as well as an indication of whether the customer accepts or rejects the recommended insurance when the contact action occurs. The retraining may use the feedback of whether the recommended insurance was accepted or rejected in order to improve the future recommendations provided by the recommendation engine.

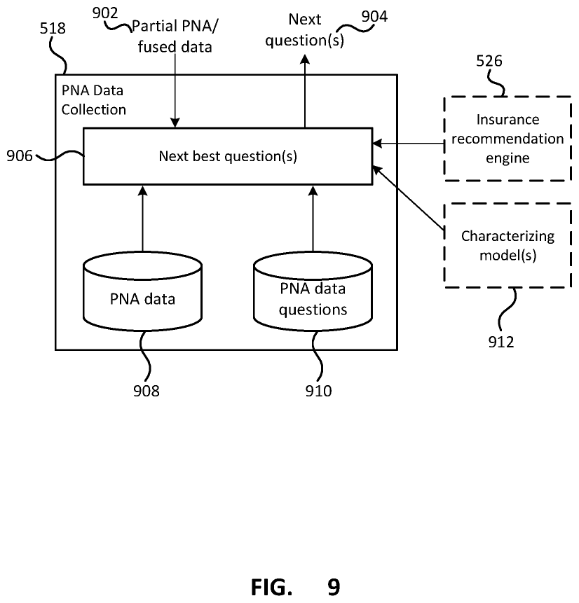

FIG. 9 depicts components of a PNA data collection component. The PNA data collection functionality 518 may receive PNA data 902, or at least partial PNA data, that may be fused with other data and generates a next best question, or questions, 904 for collecting further PNA data. The PNA data collection may include next best question(s) 906 that uses PNA data 908 that may have already been collected to determine one or more PNA questions 910 to ask next. The next best question may be based on the insurance recommendation engine 526 as well as one or more other characterizing models 912. For example, a characterizing model 912 may include a smoker propensity model that can predict a likelihood that the customer is or is not a smoker and reduce the number of questions required in the assessment and also estimate the risk score for underwriting and premium pricing.

As described above, it is possible to predict life events base on the person and personal history and matching it to the product that the client needs, and then identifying the risks by identifying the event and the probability of the event occurring based on where they are in the client journey and plan to mitigate the risks. Using the above predictions, the PNA data collection functionality can identify the next best question for the advisor to pose to the client, possibly along with a timing of the question.

The PNA data for a customer may be collected at different times through different user interface channels. For example, a customer may begin researching insurance products online through a self-serve user interface and may complete a number of PNA data collection questions and the customer's responses stored. The customer may contact an advisor or broker and the PNA data collection may retrieve the customer's previous responses and continue the PNA data collection without the advisor or broker having to restart the PNA questions and so providing a warm hand-off for the customer to the advisor or broker.

The above has described a system that uses an insurance recommendation engine to recommend different insurance products based on various factors. The recommendations may be used to improve the PNA data collection process by determining recommended products to suggest or discuss with the customer at different times in the customer's life.

Further, the one of more recommendations provided by the recommendation engine may be ranked based on scores that estimate the best fit by applying the trained models and the latest input data from the client profile, the PNA and historical datasets. This may allow the advisor and client to offer a ranked choice of options for the client for different insurance products and coverage amounts. Furthermore, the trained models can provide risk scores based on the latest input data from the client profile, the PNA and historical datasets for further processing by underwriting for approval of the insurance application.

A recommendation engine was built, trained and tested. The model comprised three different categories of insurance recommendation models. A first life insurance recommendation model had the same architecture as described above with reference to FIG. 2. The term/perm classifier used a trained XGB classifier, the term policy classifier used a trained random forest classifier and the perm policy classifier used an LGBM classifier. Both of the face amount regressors used trained random forest regressors. A critical illness insurance recommendation model had the same architecture as described above with reference to FIG. 3, with the policy classifier being a trained XGB classifier and the face amount regressor being a trained random forest regressor. A disability illness insurance recommendation model had the same architecture as described above with reference to FIG. 3, with the policy classifier being a trained LGBM classifier and the face amount regressor being a trained random forest regressor.

The classification models were tested using confusion matrixes, classification reports, ROC curves as well as metrics such as accuracy, precision, recall, F1 and AUC scores. The results are provided below in Table 1, which shows strong performances for the classification models.

TABLE 1
Classification model evaluation results

| | | Accu- | Preci- | Re- | F1 |
|---|---|---|---|---|---|
| Name | Model | racy | sion | call | score |
| Life - term/perm | XGB classifier | 85% | 83% | 88% | 855 |
| Life - term policy | Random forest | 97% | 97% | 97% | 97% |
| | classifier | | | | |
| Life - perm policy | LGBM classifier | 86% | 86% | 86% | 86% |
| Critical illness | XGB classifier | 93.5% | 92% | 95% | 93% |
| policy | | | | | |
| Disability policy | LGBM Classifier | 70% | 70% | 70% | 70% |

The regressor models were evaluated with metrics including MAE, MSE, RMSE, R2, RMSLE and MAPE. Some of the results are provided below in Table 2.

TABLE 2
Regressor model evaluation results

| Name | Model | MSE | RMSE | MAE | R2 |
|---|---|---|---|---|---|
| Life perm | Random forest regressor | 0.5 | 0.7 | 0.5 | 0.2 |
| coverage | | | | | |
| Life term | Random forest regressor | 0.8 | 0.9 | 0.7 | 0.2 |
| coverage | | | | | |
| CI coverage | Random forest regressor | 0.8 | 0.9 | 0.7 | 0.15 |
| Disability | Random forest regressor | 0.7 | 0.8 | 0.6 | 0.2 |
| coverage | | | | | |

While the regressor models may not have performed as well as the classification models, it is believes that the performance is sufficient to provide useful recommendations. Further, the performance is believed to be at least partially a result of the training data, which uses policy recommendations based on business rules. The models of the recommendation engine may be periodically retrained using the generated recommendation data, along with other collected information or predicted information, such as the predicted personas, life stage milestones etc. to improve the performance of the models. The results of the recommendations may also be tracked and used as feedback in the training/retraining of the models. For example if a customer purchases a recommended product or not can be used as positive or negative feedback in the training of the models.

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

What is claimed is:

1. A computer implemented method of recommending insurance policies comprising:
applying one or more trained policy recommendation models to personal needs assessment (PNA) data collected from an insurance customer to generate a recommendation of one or more insurance policies each of the insurance policies including a policy type and policy amount, each of the trained policy recommendation models generating a policy recommendation based on a plurality of respective features;
applying the generated recommendation of the one or more insurance policies to a policy explainability model to identify one or more of the plurality of features of the respective models that led to the generated recommendation;
mapping the one or more features identified by the policy explainability model to a human-understandable explanation of the policy recommendation; and
outputting the generated policy recommendation and the human-understandable explanation of the policy recommendation for presentation to the insurance customer.

2. The method of claim 1, wherein each of the trained policy recommendation models receive as input:
life stage milestone data;
profile demographic data;
historical purchase data; and
the PNA data.

3. The method of claim 1, wherein each of the trained policy recommendation models are trained on one or more of:
historical customer dataset; and
3^{rd} party dataset.

4. The method of claim 3, further comprising:
collecting the PNA data from the insurance customer; and
fusing the PNA data with data from the 3^{rd} party dataset prior to applying the PNA data to the one or more trained policy recommendation models.

5. The method of claim 1, wherein one or more of the policy recommendation models comprises:
a policy model for recommending a policy type based on the PNA data; and
a policy amount model for recommending a policy amount based on the PNA data and recommended policy type.

6. The method of claim 5, wherein the policy model is a classifier model and the policy amount model is a regression model.

7. The method of claim 1, wherein one or more of the policy recommendation models further comprise:
a policy sub-type model for recommending a sub-type of the policy type;
a first policy model for recommending a first policy sub-type based on the PNA data when the policy sub-type model recommends a first sub-type of the policy type;
a first policy amount model for recommending a policy amount based on the PNA data and recommended first policy sub-type when the policy sub-type model recommends a first sub-type of the policy type;
a second policy model for recommending a second policy sub-type based on the PNA data when the policy sub-type model recommends a second sub-type of the policy type; and
a second policy amount model for recommending a policy amount based on the PNA data and recommended second policy sub-type when the policy sub-type model recommends a second sub-type of the policy type.

8. The method of claim 1, further comprising collecting the PNA data by:
presenting the insurance customer with a first set of questions to collect a first subset of the PNA data; and
determining a second set of questions to collect a second subset of the PNA data based on the first subset of PNA data.

9. The method of claim 8, wherein the first set of questions and the second set of questions are determined based on the one or more policy recommendation models applied t the first subset of the PNA data.

10. The method of claim 9, wherein the first set of questions and the second set of questions are determined based on determined feature importance of the one or more policy recommendation models.

11. The method of claim 10, wherein the collected PNA data includes collecting data on one or more of:
life stage milestones of the insurance customer that have occurred; and
anticipated life stage milestones that are expected to occur.

12. The method of claim 11, wherein the one or more trained policy recommendation models generate the policy recommendation by:
predicting a persona type of the insurance customer using the collected PNA data;
mapping the persona to corresponding life stage milestones; and
determining the policy recommendation based on the corresponding life stage milestones of the predicted persona.

13. The method of claim 12, further comprising:
generating and storing a future contact plan based on the predicted life stage milestone timeline, wherein the future contact plan comprises dates for performing a contact action comprising one or more of:
contacting the insurance customer to update collected PNA data of the insurance customer; and
contacting the insurance customer to recommend an insurance product or change to an existing insurance product.

14. The method of claim 13, further comprising:
receiving an indication of the insurance customer accepting or rejecting the recommended insurance product; and
re-training one or more of the policy recommendation models using the received indication.

15. The method of claim 13, wherein the recommended insurance product or change to the existing insurance product is determined using the one or more trained policy recommendation models and predicted PNA data for each life stage milestone of the predicted life stage milestone timeline.

16. The method of claim 13, further comprising:
periodically processing the stored future contact plan to determine if a date of the dates for contacting the insurance customer has occurred; and
when one of the dates of the dates for contacting the insurance customer has occurred, performing the contact action.

17. The method of claim 8, wherein the second set of questions is determined based on one or more characterizing models that characterize one or more characteristics of the customer.

18. The method of claim 17, wherein one of the one or more characterizing models comprises a smoker propensity model that characterizes the customer as a smoker or not.

19. The method of claim 8, wherein at least a portion of the PNA data is processed using natural language processing (NLP).

20. The method of claim 1, further comprising collecting the PNA data by:
collecting a first portion of the PNA data through a first user interface channel;
storing the first portion of the PNA data;
subsequently retrieving the first portion of the PNA data and identifying a subsequent question for collecting a second portion of PNA data; and
collecting the second portion of PNA data through a second user interface channel.

21. The method of claim 8, further comprising:
predicting a probability that a plurality of lifestage milestones will occur within a given set of time;
predicting a persona type of the insurance customer;
predicting future insurance needs of the insurance customer based on the predicted probability that the plurality of lifestage milestones will occur and the predicted persona type;
determining a difference between current insurance of the insurance customer and future insurance needs; and
based on the determined difference, generating a contact action associated with the insurance customer.

22. A non-transitory computer readable medium storing instructions which when executed by a processor of a computing device configure the computing device to perform a method comprising:
applying one or more trained policy recommendation models to the personal needs assessment (PNA) data collected from an insurance customer to generate a recommendation of one or more insurance policies each of the insurance policies including a policy type and policy amount, each of the trained policy recommendation models generating a policy recommendation based on a plurality of respective features;
applying the generated recommendation of the one or more insurance policies to a policy explainability model to identify one or more of the plurality of features of the respective models that led to the generated recommendation;
mapping the one or more features identified by the policy explainability model to a human-understandable explanation of the policy recommendation; and
outputting the generated policy recommendation and the human-understandable explanation of the policy recommendation for presentation to the insurance customer.

23. A computing device comprising:
a processor for executing instructions; and
a memory storing instructions which when executed by the processor configure the computing device to perform a method according to:
applying one or more trained policy recommendation models to the personal needs assessment (PNA) data collected from an insurance customer to generate a recommendation of one or more insurance policies each of the insurance policies including a policy type and policy amount, each of the trained policy recommendation models generating a policy recommendation based on a plurality of respective features;
applying the generated recommendation of the one or more insurance policies to a policy explainability model to identify one or more of the plurality of features of the respective models that led to the generated recommendation;
mapping the one or more features identified by the policy explainability model to a human-understandable explanation of the policy recommendation; and
outputting the generated policy recommendation and the human-understandable explanation of the policy recommendation for presentation to the insurance customer.
